(19) United States
(12) Patent Application Publication
(10) Pub. No.: US 2007/0055186 A1
(43) Pub. Date: Mar. 8, 2007

(54) Massage device having multiple massage modes

(75) Inventor: Wen-Hsu Hsieh, Chang-Hua City (TW)

Correspondence Address: CHARLES E. BAXLEY, ESQ., 90 JOHN STREET, THIRD FLOOR, NEW YORK, NY, 10038, US

(73) Assignee: Kuang Yu Metal Working Co., Ltd.

(21) Appl. No.: 11/220,506

(22) Filed: Sep. 7, 2005

(51) Int. Cl. A61H 7/00

(52) U.S. Cl. 601/99; 601/101; 601/103

(57) ABSTRACT

A massage device having multiple massage modes comprises: a base, a first transmission shaft installed in the base, at either ends of the first transmission shaft disposed a transmission member, a second transmission shaft installed in the base, at either ends of the second transmission shaft disposed a coupled block connected to the transmission member, and two massage wheel assemblies installed on the transmission member of the first transmission shaft. By controlling the rotating direction of the first transmission shaft, the massage mode of the massage rollers can be changed (the massage rollers will move in a parallel manner or move toward or away from each other regularly).

### BACKGROUND OF THE INVENTION

1. Field of the Invention

The present invention relates to a massage device, and more particularly to a massage device having multiple massage modes.

2. Description of the Prior Art

Massage can help release muscular fatigue, for example, a massage chair can relax the tensioned muscle group through back muscle, acupoint massage and spinal traction, it is especially helpful in treating those who suffer from chronic muscular ache or poor blood circulation, helping them recover from muscle fatigue and enhancing their blood circulation.

A conventional massage chair generally comprises a motor that serves to drive a transmission mechanism, and then the transmission mechanism rotate a plurality of massage rollers, thus producing a rolling, kneading, rubbing and stroking function. However, one of the shortcomings of this massage chair is that the massage rollers only can perform regular movements.

In terms of the kneading and rubbing motion, if the transmission mechanism drives the massage rollers to move on the user's back in a parallel manner (the rollers move in the same direction), the massage device only can perform a parallel type kneading and rubbing massage. If the massage rollers move in opposite directions, then the parallel type kneading and rubbing massage can't be performed.

To enable the massage rollers to perform different massages (the rollers move in opposite directions or in parallel), JP Patent No. 2001-314471 discloses a massage device that has a left and a right rotating shafts, and the left and right shafts can drive the massage mechanisms to move in parallel manner or in opposite directions, thus providing different massage effects.

However, the transmission mechanism of this type massage device is too complicated in structure and its production cost is accordingly high.

The present invention has arisen to mitigate and/or obviate the afore-described disadvantages.

### SUMMARY OF THE INVENTION

The primary objective of the present invention is to provide a massage device having multiple massage modes and comprising: a base, a first transmission shaft, a second transmission shaft and a plurality of massage wheel assemblies. By controlling the rotating direction of the first transmission shaft, the massage mode of the massage rollers can be changed (the massage rollers will move in a parallel manner or move toward or away from each other regularly).

A massage device having multiple massage modes comprises:

a base;

a first transmission shaft installed in the base, at either ends of the first transmission shaft disposed a transmission member;

a second transmission shaft installed in the base, at either ends of the second transmission shaft disposed a coupled block connected to the transmission member; and

two massage wheel assemblies installed on the transmission member of the first transmission shaft;

wherein the first transmission shaft has a driving portion in which is formed with a positioning hole, on the driving portion is installed a bushing, in the bushing is formed with a radial elongated hole that is aligned to the positioning hole, in the elongated hole are defined a plurality of opposite abutting surfaces, the busing is provided at an end thereof with an eccentric shaft for cooperating with the transmission member, a positioning member is inserted in the positioning hole and is confined within the elongated hole, when the first transmission shaft rotates clockwise and counterclockwise, the positioning member will move within the elongated hole and then push against one of the abutting surface, making the bushing rotate clockwise and counterclockwise along with the first transmission shaft, so as to provide different massage modes.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a massage device in accordance with a first embodiment of the present invention;

FIG. 2 is an exploded view of a transmission shaft and the bushing thereof in accordance with the first embodiment of the present invention;

FIG. 3 is an operational view of the first embodiment of the present invention;

FIG. 4 is an operation view of showing the bushing in accordance with the first embodiment of the present invention;

FIG. 5 is an operational view of showing the massage wheel assemblies in accordance with the first embodiment of the present invention;

FIG. 6 is another operational view of showing the massage wheel assemblies in accordance with the first embodiment of the present invention;

FIG. 7 is another operational view of the first embodiment of the present invention;

FIG. 8 is another operational view of showing the massage wheel assemblies in accordance with the first embodiment of the present invention;

FIG. 9 is another operational view of the first embodiment of the present invention;

FIG. 10 is another operation view of showing the bushing in accordance with the first embodiment of the present invention;

FIG. 11 is another operational view of showing the massage wheel assemblies in accordance with the first embodiment of the present invention;

FIG. 12 is another operational view of showing the massage wheel assemblies in accordance with the first embodiment of the present invention;

FIG. 13 is an exploded view of a transmission shaft and the bushing thereof in accordance with a second embodiment of the present invention;

FIG. 14 is an operational view of showing the massage wheel assemblies in accordance with the second embodiment of the present invention;

FIG. 15 is another operational view of showing the massage wheel assemblies in accordance with the second embodiment of the present invention.

### DETAILED DESCRIPTION OF THE PREFERRED EMBODIMENTS

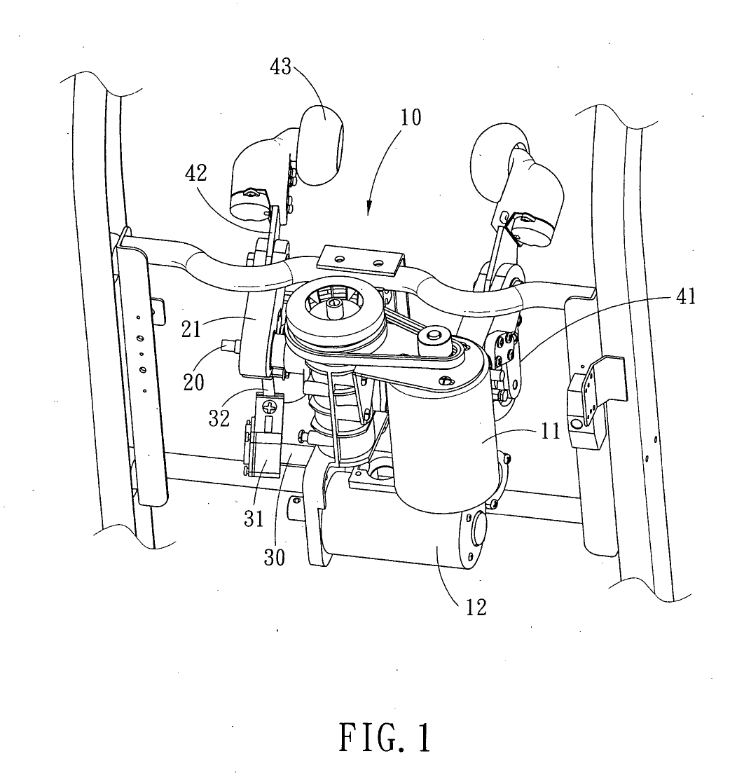

Referring to FIG. 1, a massage device capable of performing multiple massages in accordance with a first preferred embodiment of the present invention is shown and comprises: a base 10, a first transmission shaft 20, a second transmission shaft 30, a first massage wheel assembly 41 and a second massage wheel assembly 42.

The base 10 is provided with two motors 11 and 12.

The first transmission shaft 20 is rotatably installed on the base 10 and driven by the motor 11, and at either ends of the first transmission shaft 20 is disposed a transmission member 21.

The second transmission shaft 30 is rotatably installed on the base 10 and driven by the motor 12, and at either ends of the second transmission shaft 30 is disposed a coupled block 31. Between the coupled block 31 and the transmission member 21 is pivotally arranged a connecting rod 32.

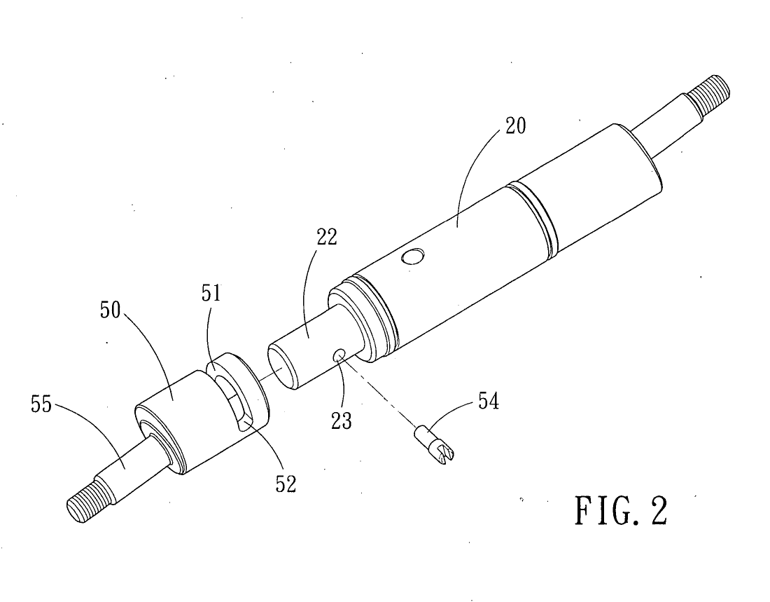

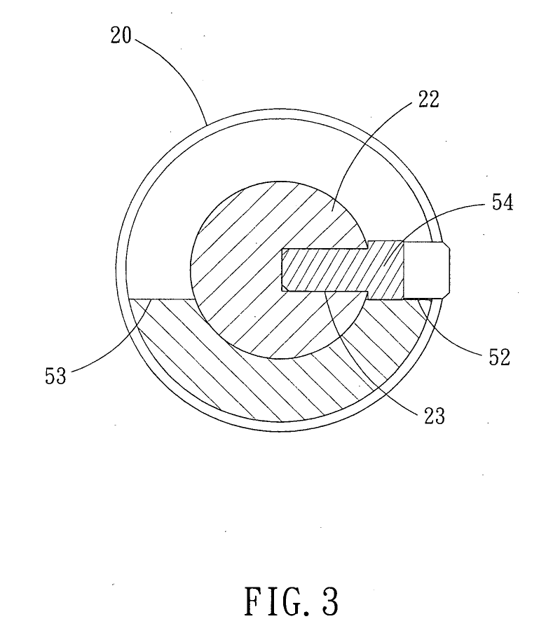

The first and second massage wheel assemblies 41 and 42 are disposed on the transmission member 21 at either ends of the first transmission shaft 20 and each has a plurality of massage rollers 43. The motors 11 and 12 drive the first and second massage wheel assemblies 41 and 42 to rotate, performing rolling, kneading, rubbing and stroking motions. The abovementioned embodiment is similar in structure and operation to the conventional techniques, so further remarks on this matter will be omitted. The principle characteristics of the invention are set forth below with reference to FIGS. 2 and 3.

The first transmission shaft 20 is formed at an end thereof with a coaxial driving portion 22, and in the outer radial surface of the driving portion 22 is defined a positioning hole 23.

A bushing 50 is installed on the driving portion 22 of the first transmission shaft 20, and on the outer surface of the bushing 50 is defined a radial elongated hole 51 in which are formed a plurality of opposite abutting surfaces 52 and 53. The elongated hole 51 of the bushing 50 is aligned to the positioning hole 23 in the driving portion 22, and a positioning member 54 is inserted through the elongated hole 51 and into the positioning hole 23. The bushing 50 is further formed at an end thereof with an eccentric shaft 55 that is to be coupled to the transmission member 21.

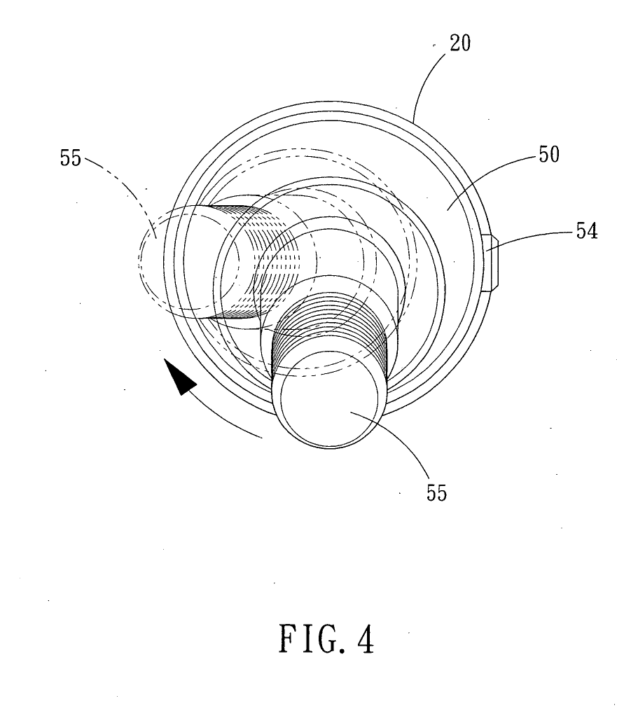

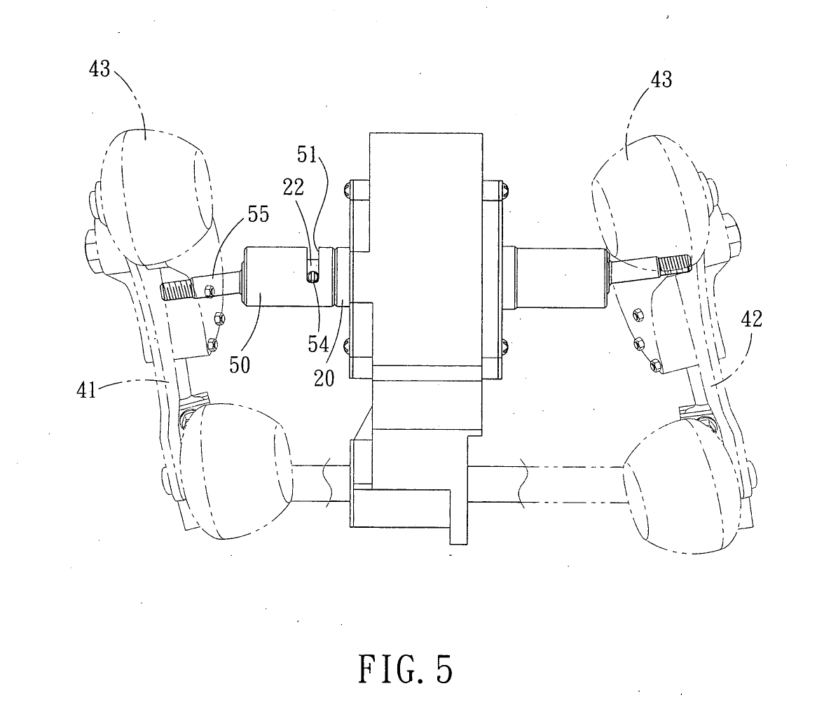

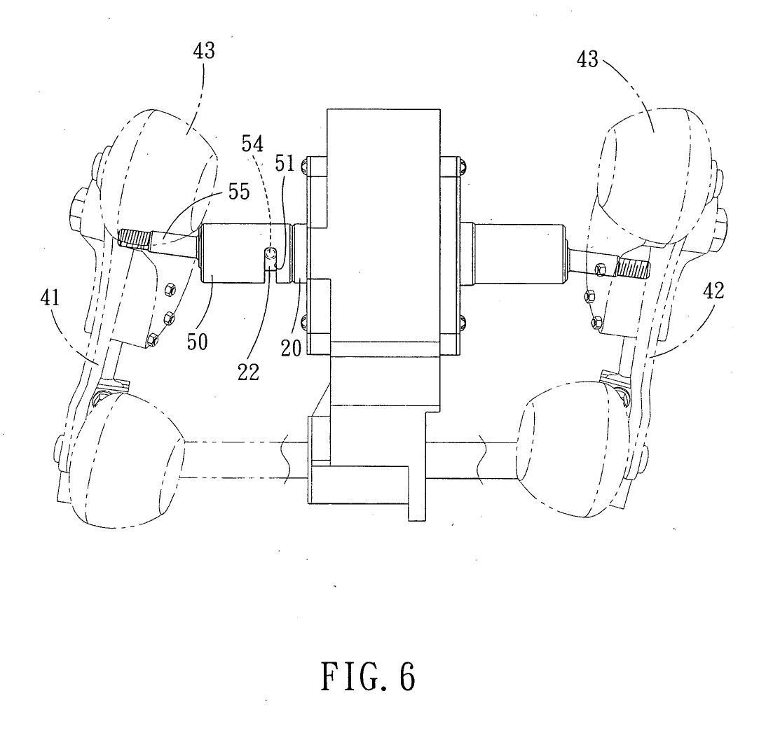

For a better understanding of the present invention, its operation and function, reference should be made to FIGS. 3 and 4. When the first transmission shaft 20 rotates clockwise, it will use the positioning member 54 to push the abutting surface 52 of the elongated hole 51 of the bushing 50. Due to the positioning member 54 is installed in the positioning hole 23 of the driving portion 22 of the first transmission shaft 20 and is restricted within the elongated hole 51 of the bushing 50, the driving portion 22 of the first transmission shaft 20 will use the positioning member 54 to rotate the bushing 50 clockwise. And the eccentric shaft 55 of the busing 50 is connected to the coupled block 31 (not shown), thereby the massage rollers 43 on the massage wheel assemblies 41 and 42 will move synchronously in a parallel manner (without changing the distance between the massage rollers 43), as shown in FIGS. 5 and 6.

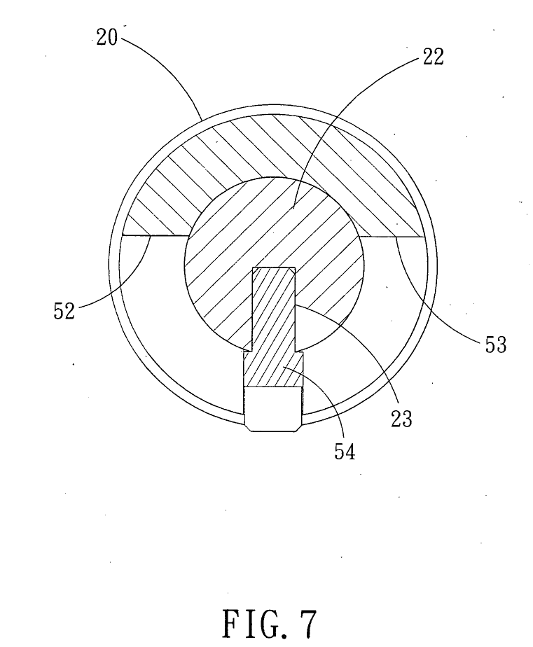

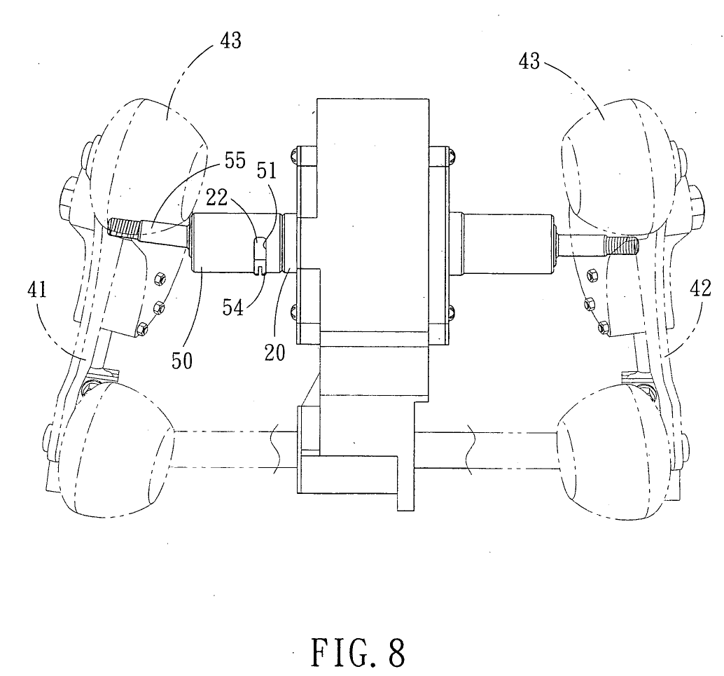

Referring to FIGS. 7 and 8, when the first transmission shaft 20 is rotated counterclockwise, due only one end of the first transmission shaft 20 is provided with the driving portion 22 and the bushing 50, another end the first transmission shaft 20 will drive the first massage wheel assembly 41 and the massage rollers 43 thereon to rotate continuously. The driving portion 22 of the first transmission shaft also will rotate counterclockwise, and the positioning member 54 in the positioning hole 23 of the driving portion 22 will move away from the abutting surface 52 of the bushing 50, therefore, the positioning member 54 will rotate counterclockwise along with the driving portion 22. At this moment, the bushing 50 will stop rotating since it is not being pushed by the positioning member 54, that is, the bushing 50 and the driving portion 22 are in an idle state. The first and second massage wheel assemblies 41 and 42 driven by the bushing 50 will also stop rotating, and as a result, the distance between the massage rollers 43 on the first and second massage wheel assemblies 41 and 42 will be changed.

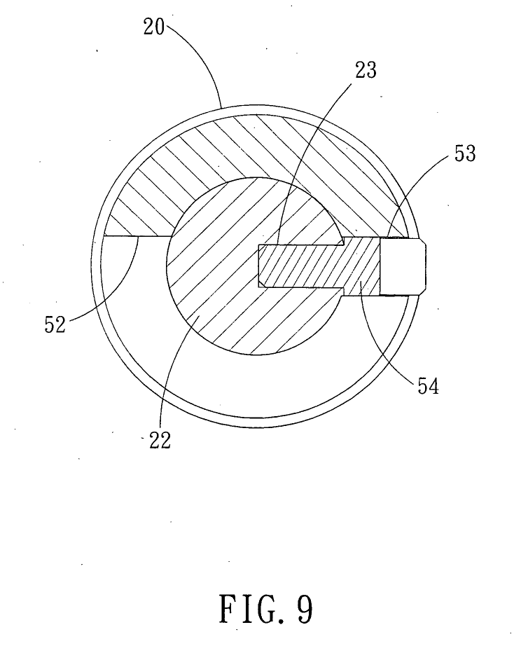

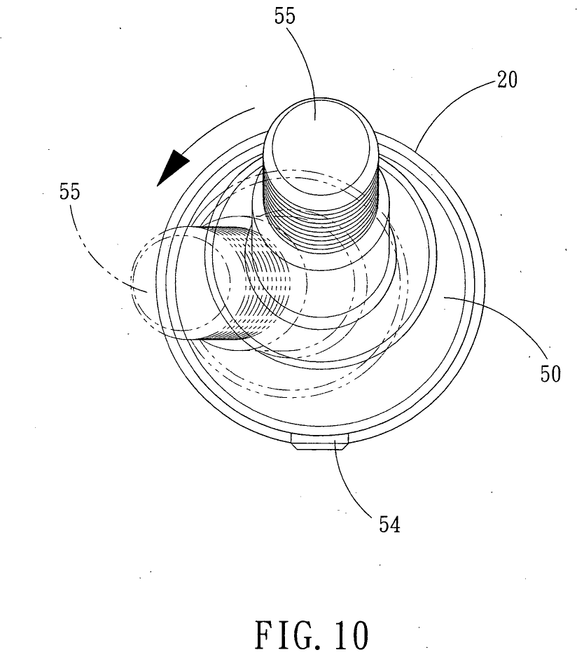

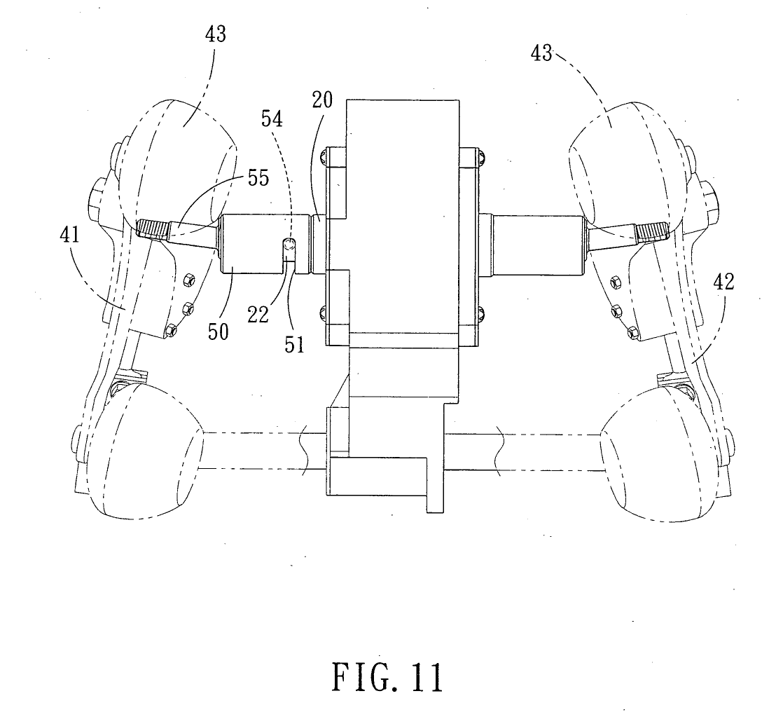

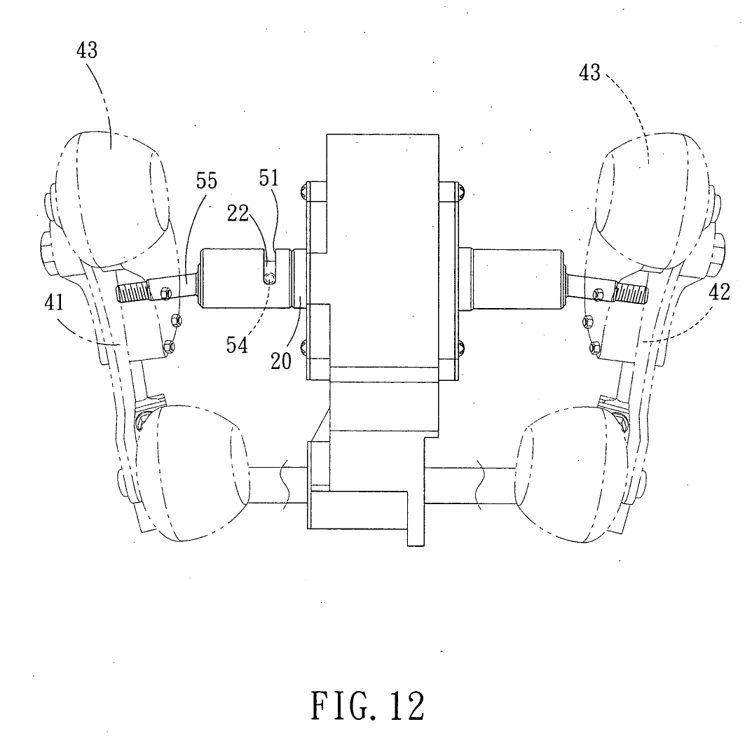

Referring next to FIGS. 9 and 10, when the first transmission shaft 20 rotates clockwise continuously, the positioning member 54 in the positioning hole 23 of the driving portion 22 will then move to and push against the abutting surface 53 of the elongated hole 51 of the bushing 50, making the bushing 50 rotate counterclockwise together with the first transmission shaft 20. At this moment, the distance between the massage rollers 43 on the first and second massage wheel assemblies 41 and 42 will stop changing, and thus the massage rollers 43 will move toward or away from each other regularly, as shown in FIGS. 11 and 12.

Therefore, by controlling the rotating direction of the first transmission shaft 20, the massage mode of the massage rollers 43 can be changed (the massage rollers 43 move in a parallel manner or move toward or away from each other regularly).

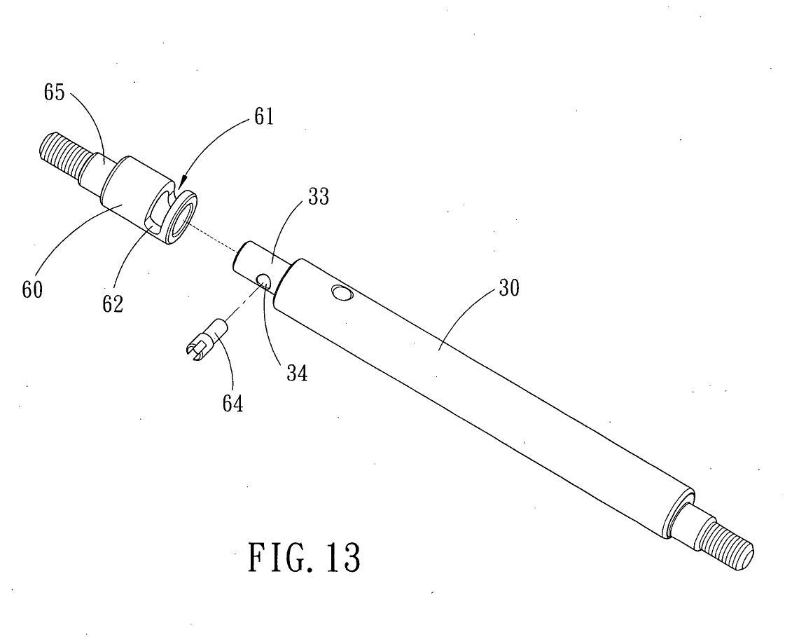

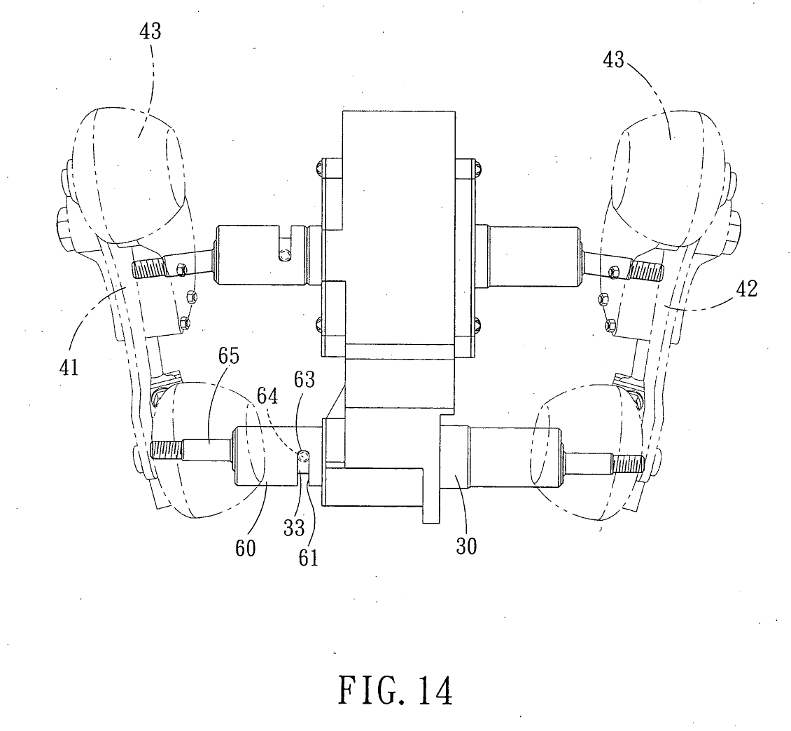

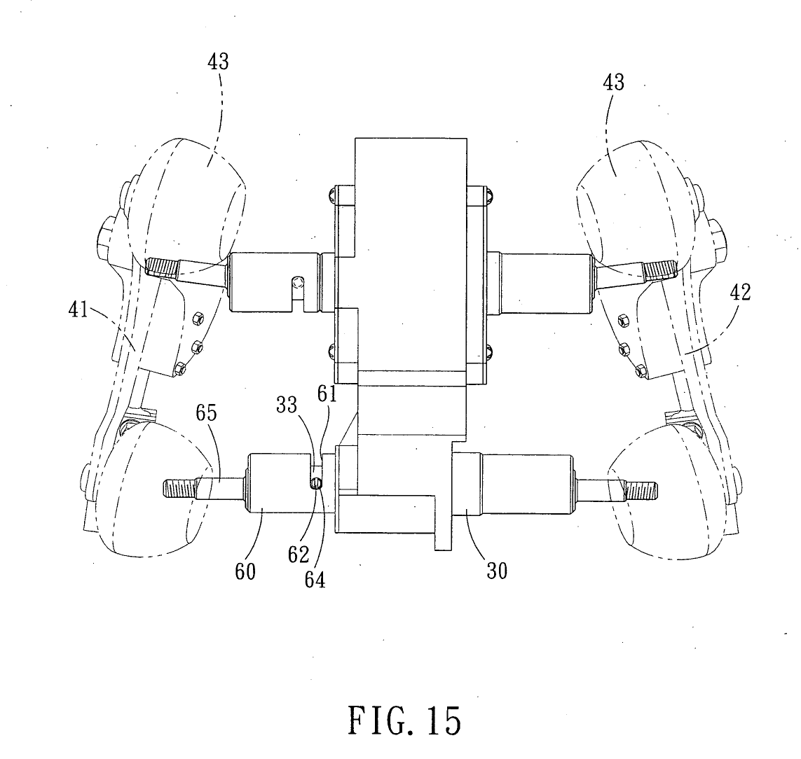

Referring to FIGS. 13-15, a massage capable of performing multiple massages in accordance with a second preferred embodiment of the present invention is shown and identical to that of the first embodiment, except that:

At an end of the second transmission shaft 30 is formed a coaxial driving portion 33, and on the outer surface of the driving portion 33 is formed a positioning hole 34.

A bushing 60 is installed on the driving portion 33 of the second transmission shaft 30, and on the outer surface of the bushing 60 is defined a radial elongated hole 61 in which are formed abutting surfaces 62 and 63. The elongated hole 61 of the bushing 60 is aligned to the positioning hole 34 in the driving portion 33, and a positioning member 64 is inserted through the elongated hole 61 and into the positioning hole 34. The bushing 60 is further formed at an end thereof with an eccentric shaft 65 that is to be coupled to the transmission member 31.

During clockwise or counterclockwise rotation of the second bushing, the positioning member 64 in the positioning hole 34 of the driving portion 33 will push against the abutting surfaces 62 and 63 in the elongated hole 61 of the bushing 60, making the bushing 60 rotate in the same direction of the second transmission shaft 20. The massage device of the second embodiment also can massage in different modes.

It is to be noted that the positioning member can be positioned in the positioning hole of the first and second transmission shafts in different manners, such as by means of threads, friction force, and etc.

While we have shown and described various embodiments in accordance with the present invention, it should be clear to those skilled in the art that further embodiments may be made without departing from the scope of the present invention.

What is claimed is:

1. A massage device having multiple massage modes comprising:
a base;
a first transmission shaft installed in the base, at either ends of the first transmission shaft disposed a transmission member;
a second transmission shaft installed in the base, at either ends of the second transmission shaft disposed a coupled block connected to the transmission member; and
two massage wheel assemblies installed on the transmission member of the first transmission shaft;
wherein the first transmission shaft has a driving portion in which is formed with a positioning hole, on the driving portion is installed a bushing, in the bushing is formed with a radial elongated hole that is aligned to the positioning hole, in the elongated hole are defined a plurality of opposite abutting surfaces, the busing is provided at an end thereof with an eccentric shaft for cooperating with the transmission member, a positioning member is inserted in the positioning hole and is confined within the elongated hole, when the first transmission shaft rotates clockwise and counterclockwise, the positioning member will move within the elongated hole and then push against one of the abutting surface, making the bushing rotate clockwise and counterclockwise along with the first transmission shaft, so as to provide different massage modes.

2. The massage device having multiple massage modes as claimed in claim 1, wherein the first transmission shaft is defined with the coaxial driving portion.

3. A massage device having multiple massage modes comprising:
a base;
a first transmission shaft installed in the base, at either ends of the first transmission shaft disposed a transmission member;
a second transmission shaft installed in the base, at either ends of the second transmission shaft disposed a coupled block connected to the transmission member; and
two massage wheel assemblies installed on the transmission member of the first transmission shaft;
wherein the second transmission shaft has a driving portion in which is formed with a positioning hole, on the driving portion is installed a bushing, in the bushing is formed with a radial elongated hole that is aligned to the positioning hole, in the elongated hole are defined a plurality of opposite abutting surfaces, the busing is provided at an end thereof with an eccentric shaft for cooperating with the transmission member, a positioning member is inserted in the positioning hole and is confined within the elongated hole, when the second transmission shaft rotates clockwise and counterclockwise, the positioning member will move within the elongated hole and then push against one of the abutting surface, making the bushing rotate clockwise and counterclockwise along with the second transmission shaft, so as to provide different massage modes.

4. The massage device having multiple massage modes as claimed in claim 3, wherein the second transmission shaft is defined with the coaxial driving portion.
